(19) United States
(12) Patent Application Publication
(10) Pub. No.: US 2024/0325888 A1
(43) Pub. Date: Oct. 3, 2024

(54) VIRTUAL VEHICLE CONTROL METHOD AND APPARATUS, DEVICE, AND COMPUTER-READABLE STORAGE MEDIUM

(71) Applicant: Tencent Technology (Shenzhen) Company Limited, Shenzhen (CN)

(72) Inventors: Haosheng XUE, Shenzhen (CN); Jinlong Tu, Shenzhen (CN); Zhipeng Luo, Shenzhen (CN)

(21) Appl. No.: 18/740,365

(22) Filed: Jun. 11, 2024

Related U.S. Application Data
(63) Continuation of application No. PCT/CN2023/093738, filed on May 12, 2023.

(30) Foreign Application Priority Data
May 20, 2022 (CN) 202210557452.4

(51) Int. Cl. A63F 13/422; A63F 13/573; A63F 13/803

(52) U.S. Cl. CPC A63F 13/422; A63F 13/573; A63F 13/803

(57) ABSTRACT

This application provides a virtual vehicle control method performed by an electronic device. The method includes: displaying a virtual vehicle in a virtual scene during controlling the virtual vehicle; during a continued first operation on a first direction component, receiving a second operation triggered on a foot brake component and a third operation triggered on an accelerator component sequentially; determining a driving speed and a driving state of the virtual vehicle at a trigger moment of the third operation; and in response to the driving speed of the virtual vehicle at the trigger moment of the third operation being greater than a speed threshold and the driving state of the virtual vehicle at the target time point being a straight-forward driving state, controlling the virtual vehicle to perform inertial drift in a direction indicated by the first direction component.

### CROSS-REFERENCE TO RELATED APPLICATIONS

This application is a continuation application of PCT Patent Application No. PCT/CN2023/093738, entitled “VIRTUAL VEHICLE CONTROL METHOD AND APPARATUS, DEVICE, AND COMPUTER-READABLE STORAGE MEDIUM” filed on May 12, 2023, which claims priority to Chinese Patent Application No. 202210557452.4, entitled “VIRTUAL VEHICLE CONTROL METHOD AND APPARATUS, DEVICE, AND COMPUTER-READABLE STORAGE MEDIUM” filed on May 20, 2022, both which are incorporated herein by reference in their entirety.

### FIELD OF THE TECHNOLOGY

Embodiments of this application relate to the field of Internet technologies, and in particular, to a virtual vehicle control method and apparatus, a device, and a computer-readable storage medium.

### BACKGROUND OF THE DISCLOSURE

With the continuous development of online games and terminal technologies, increasing game applications can be installed on a terminal. As competitive games, car-racing games are popular among increasing players because of cool skills and super speed experience. For these car-racing games, right and left directions as well as inertial drift can be performed during racing.

In related art, a player controls a moving direction of a vehicle by operating a direction component. When needing to use an inertial drift skill, the player selects both the direction component and a drift component. When selection duration of the drift component is within a duration range, the vehicle can be controlled to perform inertial drift in a direction corresponding to the direction component.

### SUMMARY

Embodiments of this application provide a virtual vehicle control method and apparatus, a device, and a computer-readable storage medium, to resolve problems in related art that a player has poor control over a vehicle, a vehicle control manner is not flexible, game experience is poor, and consistency with a manner for operating a real vehicle to perform inertial drift is poor. The technical solutions are as follows.

According to an aspect, an embodiment of this application provides a virtual vehicle control method, performed by an electronic device, the method including:
displaying a virtual vehicle in a virtual scene;
during a continued first operation on a first direction component, receiving a second operation triggered on a foot brake component and a third operation triggered on an accelerator component sequentially;
determining a driving speed and a driving state of the virtual vehicle at a trigger moment of the third operation; and
in response to the driving speed of the virtual vehicle at the trigger moment of the third operation being greater than a speed threshold and the driving state of the virtual vehicle at the target time point being a straight-forward driving state, controlling the virtual vehicle to perform inertial drift in a direction indicated by the first direction component.

According to another aspect, an embodiment of this application provides an electronic device, including a processor and a memory, the memory having at least one piece of program code stored therein, and the at least one piece of program code being loaded and executed by the processor to cause the electronic device to implement the virtual vehicle control method according to any one of the foregoing implementations.

According to another aspect, a non-transitory computer-readable storage medium is further provided, having at least one piece of program code stored thereon, the at least one piece of program code being loaded and executed by a processor to cause a computer to implement the virtual vehicle control method according to any one of the foregoing implementations.

The technical solutions provided in embodiments of this application at least have the following beneficial effects.

According to the technical solutions provided in embodiments of this application, when a virtual vehicle is controlled to perform inertial drift, a player only needs to operate a direction component, a foot brake component, and an accelerator component to control the virtual vehicle to perform the inertial drift. In this way, the method improves control of the player on a vehicle, to enable a vehicle control manner to be flexible, thereby improving game experience of the player.

In addition, the direction component, the accelerator component, and the foot brake component are operated to control the virtual vehicle to perform the inertial drift, and this is consistent with a manner of operating a real vehicle to perform inertial drift, so that authenticity of controlling the virtual vehicle for performing the inertial drift is high.

### BRIEF DESCRIPTION OF THE DRAWINGS

FIG. 1 is a schematic diagram of an implementation environment of a virtual vehicle control method according to an embodiment of this application.

FIG. 2 is a flowchart of a virtual vehicle control method according to an embodiment of this application.

FIG. 3 is a schematic diagram of display of a first scene according to an embodiment of this application.

FIG. 4 is a schematic diagram of display of a vehicle control interface according to an embodiment of this application.

FIG. 5 is a schematic diagram of display of a notification message according to an embodiment of this application.

FIG. 6 is a schematic diagram of display of a speed angle and a head angle of a virtual vehicle at a current moment according to an embodiment of this application.

FIG. 7 is a schematic diagram of display of a virtual vehicle during performing general drift according to an embodiment of this application.

FIG. 8 is a schematic diagram of display of a virtual vehicle during performing inertial drift according to an embodiment of this application.

FIG. 9 is a schematic diagram of display of a drift trajectory of general drift and a drift trajectory of inertial drift according to an embodiment of this application.

FIG. 10 is a schematic diagram of a process of controlling a virtual vehicle to perform inertial drift according to an embodiment of this application.

FIG. 11 is a flowchart of a virtual vehicle control method according to an embodiment of this application.

FIG. 12 is a schematic diagram of a structure of a virtual vehicle control apparatus according to an embodiment of this application.

FIG. 13 is a schematic diagram of a structure of a terminal device according to an embodiment of this application.

FIG. 14 is a schematic diagram of a structure of a server according to an embodiment of this application.

### DESCRIPTION OF EMBODIMENTS

To make the objectives, technical solutions, and advantages of this application clearer, the following further describes implementations of this application in detail with reference to the accompanying drawings.

For ease of understanding, terms in embodiments of this application are described first.

Virtual scene: It is a scene provided (or displayed) when an application runs on a terminal device. The virtual scene is a scene created for a virtual object to carry out an activity. The virtual object is, for example, a virtual vehicle. The virtual scene may be a two-dimensional virtual scene, a two-and-a-half-dimensional virtual scene, a three-dimensional virtual scene, or the like. The virtual scene may be a simulated scene of the real world, a semi-simulated scene of the real world, or a completely fictional scene. For example, a virtual scene in embodiments of this application is a three-dimensional virtual scene.

In related art, when needing to control a virtual vehicle, a player operates a direction component to control a moving direction of the virtual vehicle. When needing to use an inertial drift skill, the player selects both the direction component and a drift component. When selection duration of the drift component is within a duration range, the vehicle can be controlled to perform inertial drift in a direction corresponding to the direction component.

However, in the foregoing method, control of the player on a vehicle is low, a vehicle control manner is not flexible, and game experience of the player is poor. Moreover, because a real vehicle does not have a drift component, the manner in which the direction component and the drift component are selected to control the vehicle to perform the inertial drift in the foregoing method is less consistent with a manner of operating the real vehicle to perform the inertial drift.

The inertial drift is a drift skill with weak steering and a less deceleration, and is suitable for the virtual vehicle to travel around a small arc curve. The inertial drift is configured for indicating that a deceleration acceleration of a virtual vehicle in a drift state is less than a first threshold, and curvature of a formed drift trajectory is less than a second threshold. The first threshold and the second threshold are not limited in embodiments of this application. A small curvature represents the foregoing weak steering and small arc, and a less deceleration acceleration represents the foregoing less deceleration.

The inertial drift is a drift manner different from general drift. The general drift is a drift skill with strong steering and a great deceleration, and is suitable for the virtual vehicle to travel around a large arc curve. The general drift is configured for indicating that the deceleration acceleration of the virtual vehicle in the drift state is greater than a third threshold, and curvature of a formed drift trajectory is greater than a fourth threshold. Large curvature represents the foregoing strong steering and large arc, and a great deceleration acceleration represents the foregoing great deceleration. For example, a value of the third threshold and a value of the fourth threshold are not limited in embodiments of this application, provided that the third threshold is greater than the first threshold, and the fourth threshold is greater than the second threshold. To be specific, compared with the deceleration acceleration and the deceleration in an inertial drift process, the deceleration acceleration is greater and the deceleration is faster in a general drift process. Compared with the curvature of the drift trajectory formed in the inertial drift process, the curvature of the drift trajectory formed in the general drift process is larger, the steering is stronger, and the arc is larger.

In addition, the drift state is included in the foregoing descriptions. The drift state means that relative static friction occurs between a rear wheel of the virtual vehicle and a carrier surface (which is configured for the virtual vehicle to travel) in the virtual scene. A state opposite to the drift state is a non-drift state. The non-drift state means that sliding friction occurs between the rear wheel of the virtual vehicle and the carrier surface.

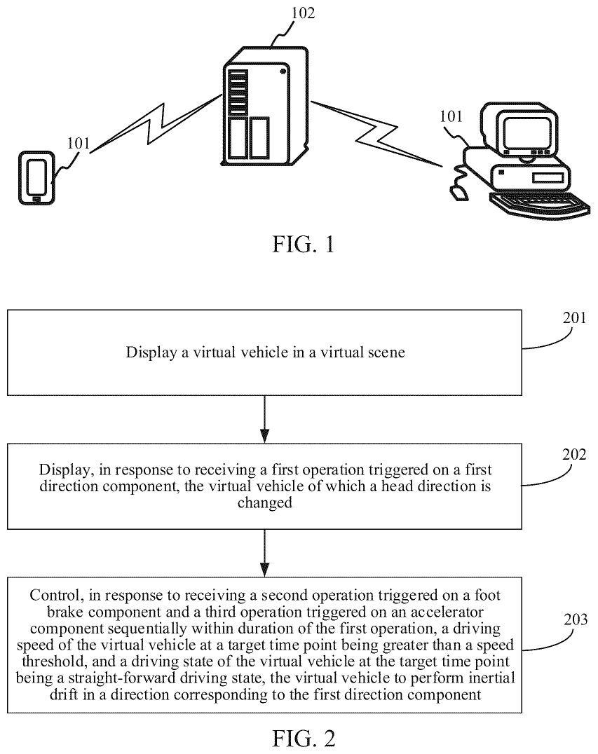

FIG. 1 is a schematic diagram of an implementation environment of a virtual vehicle control method according to an embodiment of this application. As shown in FIG. 1, the implementation environment includes a terminal device 101 and a server 102.

The terminal device 101 may be at least one of a smartphone, a game console, a desktop computer, a tablet computer, an e-book reader, and a laptop computer. The terminal device 101 is configured to perform the virtual vehicle control method according to an embodiment of this application.

The terminal device 101 may generally be one of a plurality of terminal devices. This embodiment only uses the terminal device 101 as an example for description. A person skilled in the art may know that there may be more or fewer terminal devices 101. For example, the foregoing terminal device 101 may be only one, or the foregoing terminal device 101 may be tens or hundreds, or more. A number and a device type of the terminal device are not limited in embodiments of this application.

The server 102 may be one server, a server cluster formed by a plurality of servers, or any one of a cloud computing center and a virtualization center, which is not limited in embodiments of this application. The server 102 is in communication connection with the terminal device 101 through a wired network or a wireless network. The server 102 has a data receiving function, a data processing function, and a data transmitting function. Certainly, the server 102 may alternatively have other functions, which are not limited in embodiments of this application.

Based on the foregoing implementation environment, an embodiment of this application provides a virtual vehicle control method. A flowchart of a virtual vehicle control method according to an embodiment of this application shown in FIG. 2 is used as an example. The method may be performed by the terminal device 101 in FIG. 1. As shown in FIG. 2, the method includes the following operations.

Operation 201: Display a virtual vehicle in a virtual scene.

In an exemplary embodiment of this application, an application configured for vehicle control is installed and run on the terminal device. The application is a car-racing application or a racing sports application. A type of the application is not limited in embodiments of this application.

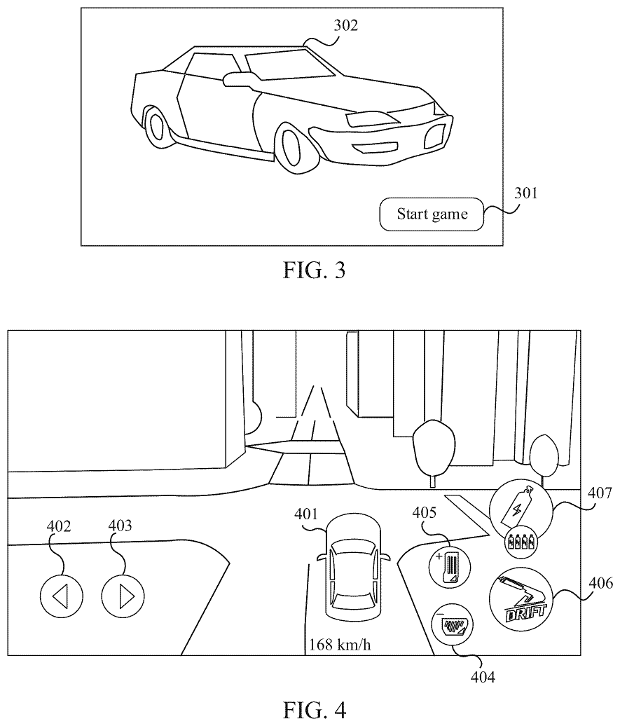

A first scene is displayed in response to a trigger operation by an interaction object on the application. The first scene is the first picture displayed when the application is selected. A start game control is displayed in the first scene. Certainly, another control may alternatively be displayed in the first scene, which is not limited in embodiments of this application. The interaction object is an object that uses the terminal device. FIG. 3 is a schematic diagram of display of a first scene according to an embodiment of this application. A start game control 301 is shown in FIG. 3. In one embodiment, a virtual vehicle 302 may alternatively be shown.

The virtual scene is displayed in response to a trigger operation of the interaction object on the start game control. The virtual vehicle is displayed in the virtual scene. In one embodiment, the virtual scene is a vehicle control interface. In other words, a to-be-controlled virtual vehicle is displayed in the vehicle control interface. For example, a first direction component, a foot brake component, and an accelerator component may alternatively be displayed in the vehicle control interface. The first direction component is configured to adjust a driving direction of the virtual vehicle, the accelerator component is configured to increase a driving speed of the virtual vehicle, and the foot brake component is configured to reduce the driving speed of the virtual vehicle.

In one embodiment, at least one of a second direction component, a hand brake component, a reset component, and an acceleration component may alternatively be displayed in the vehicle control interface, which is not limited in embodiments of this application. The second direction component is configured to adjust the driving direction of the virtual vehicle. A direction corresponding to the second direction component is different from a direction corresponding to the first direction component. For example, the direction corresponding to the second direction component is opposite to the direction corresponding to the first direction component. For example, the direction corresponding to the first direction component is left. In other words, the first direction component is configured to control the virtual vehicle to drive leftward. The direction corresponding to the second direction component is right. In other words, the second direction component is configured to control the virtual vehicle to drive rightward. Alternatively, the direction corresponding to the first direction component is right. In other words, the first direction component is configured to control the virtual vehicle to drive rightward. The direction corresponding to the second direction component is left. In other words, the second direction component is configured to control the virtual vehicle to drive leftward. The hand brake component is configured to reduce the driving speed of the virtual vehicle.

The reset component is configured to deliver the virtual vehicle to an open road and restart, and the reset component is configured to free the virtual vehicle. For example, the virtual vehicle is in a dilemma when the virtual vehicle is located on a narrow road and/or when the virtual vehicle cannot start, the reset component is used to deliver the virtual vehicle in the dilemma to the open road and restart, to get the virtual vehicle in the dilemma out of the dilemma, in other words, to free the virtual vehicle.

The acceleration component is configured to increase the driving speed of the virtual vehicle. A fourth acceleration is obtained in response to receiving a fifth operation triggered on the acceleration component. The fourth acceleration is configured for increasing the driving speed of the virtual vehicle. The fourth acceleration is higher than a first acceleration. The virtual vehicle is controlled to travel in a head direction of the virtual vehicle based on the fourth acceleration within fourth duration. The first acceleration is an acceleration obtained in response to receiving a third operation triggered on the accelerator component. The third operation and the first acceleration are also described below. Details are not described herein. The fourth duration may be set based on experience or may be adjusted based on an implementation environment, which is not limited in embodiments of this application. For example, the fourth duration is 30 seconds. The fourth acceleration is set based on experience or adjusted based on the implementation environment, which is not limited in embodiments of this application. For example, the fourth acceleration is 40 meters/second\hat{ }2 (m/s\hat{ }2). The fifth operation triggered on the acceleration component may be an operation of tapping/clicking the acceleration component or may be another operation, which is not limited in embodiments of this application.

There is also an acceleration icon below the acceleration component. One or more acceleration gas bottles are displayed in the acceleration icon. A number of gray acceleration gas bottles represents a number of acceleration gas bottles that can be currently used by the virtual vehicle. A number of white acceleration gas bottles represents a number of acceleration gas bottles that can be currently stored by the virtual vehicle. In other words, a number of white acceleration gas bottles represents a number of acceleration gas bottles that have been used by the virtual vehicle and cannot be used again until storage is completed. Every time the interaction object taps/clicks the acceleration component, a gray acceleration gas bottle in the acceleration icon turns white, and correspondingly, the virtual vehicle performs acceleration once. One acceleration may mean the foregoing controlling the virtual vehicle to travel in a head direction of the virtual vehicle based on the fourth acceleration within fourth duration. A color of the acceleration icon changing from gray to white is only an example and is not used to limit a color change of the acceleration icon. A gas in the acceleration gas bottle may be nitrogen or another gas, and an acceleration effect of different gases may be the same or different, which is not limited in embodiments of this application. For example, the same acceleration effect may mean that acceleration duration (such as the foregoing fourth duration) and an acceleration (such as the foregoing fourth acceleration) are the same. A different acceleration effect may mean that at least one of the acceleration duration and the acceleration is different.

FIG. 4 is a schematic diagram of display of a vehicle control interface according to an embodiment of this application. A to-be-controlled virtual vehicle 401, a first direction component 402, a second direction component 403, a foot brake component 404, an accelerator component 405, a hand brake component 406, and an acceleration component 407 are shown in FIG. 4. Two gray acceleration gas bottles and two white acceleration gas bottles are displayed in an acceleration icon included below the acceleration component. For example, a total of four acceleration gas bottles are displayed in the acceleration icon. Two acceleration gas bottles on the left are gray acceleration gas bottles, and two acceleration gas bottles on the right are white acceleration gas bottles. In other words, there are two acceleration gas bottles that can be currently used by the virtual vehicle, and there are two acceleration gas bottles that can be currently stored by the virtual vehicle.

The foregoing first direction component, hand brake component, foot brake component, accelerator component, reset component, acceleration component, and second direction component may be displayed in the vehicle control interface provided by the terminal device, so that the interaction object controls the virtual vehicle in the virtual scene by operating the components. Alternatively, these components may not be displayed in the vehicle control interface, and may be separate components that can interact with the terminal device, so that the interaction object controls the virtual vehicle in the virtual scene on the terminal device by operating the separate components, which are not limited in embodiments of this application. In one embodiment, the separate components may interact with the terminal device through a wired network or a wireless network.

In a possible implementation, the first acceleration is obtained based on the head direction of the virtual vehicle being a first direction and the third operation triggered on the accelerator component being received. The first acceleration is configured for increasing the driving speed of the virtual vehicle. The virtual vehicle is controlled to travel in the first direction based on the first acceleration within first duration.

The third operation triggered on the accelerator component may be a tap/click operation on the accelerator component or may be another operation, which is not limited in embodiments of this application. In one embodiment, the first acceleration is set based on experience or adjusted based on an implementation environment, which is not limited in embodiments of this application. For example, the first acceleration is 20 m/s\hat{ }2. The first duration is set based on experience or adjusted based on an implementation environment, which is not limited in embodiments of this application. For example, the first duration is 30 seconds. For example, when the third operation triggered on the accelerator component is a tap/click operation on the accelerator component or a short-time operation other than a tap/click operation, a player only needs to perform the operation for a short time, so that the virtual vehicle continues to accelerate within the first duration. The player does not need to continuously perform an operation on the accelerator component, and also does not need to perform a plurality of operations on the accelerator component, so that complexity of the operation of the player can be reduced, thereby improving game experience of the player. In addition, the terminal device does not need to continuously or frequently interact with a server based on the operation of the player, so that operating stress of the server can be reduced.

For example, the first acceleration is obtained when the head direction of the virtual vehicle is forward and the tap/click operation triggered on the accelerator component is received. The first acceleration is 20 m/s\hat{ }2. In this case, the virtual vehicle is controlled to travel forward based on the acceleration of 20 m/s\hat{ }2 within 30 seconds.

In one embodiment, a second acceleration is obtained based on the head direction of the virtual vehicle being the first direction, the driving speed of the virtual vehicle satisfying a speed requirement, and a second operation triggered on the foot brake component being received. The second acceleration is configured for reducing the driving speed of the virtual vehicle. The virtual vehicle is controlled to travel in the first direction based on the second acceleration within second duration.

The driving speed of the virtual vehicle satisfying the speed requirement means that the driving speed of the virtual vehicle is greater than 0. The second operation triggered on the foot brake component may be a tap/click operation on the foot brake component or may be another operation, which is not limited in embodiments of this application. The second acceleration is set based on experience or adjusted based on an implementation environment, which is not limited in embodiments of this application. For example, the second acceleration is 10 m/s\hat{ }2. The second duration is set based on experience or adjusted based on an implementation environment, which is not limited in embodiments of this application. For example, the second duration is 20 seconds.

For example, the second acceleration is obtained when the head direction of the virtual vehicle is forward, the driving speed of the virtual vehicle satisfies the speed requirement, and the tap/click operation triggered on the foot brake component is received. A value of the second acceleration is −10 m/s\hat{ }2. In this case, the virtual vehicle is controlled to travel in the first direction based on the driving speed of −10 m/s\hat{ }2 within 20 seconds.

In a possible implementation, a third acceleration is obtained based on the head direction of the virtual vehicle being the first direction, the driving speed of the virtual vehicle not satisfying the speed requirement, and a first operation triggered on the foot brake component being received. The third acceleration is configured for increasing the driving speed of the virtual vehicle. The virtual vehicle is controlled to travel in a second direction based on the third acceleration within third duration. The second direction is opposite to the first direction.

The driving speed of the virtual vehicle not satisfying the speed requirement means that the driving speed of the virtual vehicle is 0. The first operation triggered on the foot brake component may be a touch and hold/long press operation on the foot brake component or may be another operation, which is not limited in embodiments of this application. The first operation triggered on the foot brake component is different from the second operation triggered on the foot brake component. The third acceleration is set based on experience or adjusted based on an implementation environment, which is not limited in embodiments of this application. For example, the third acceleration is 5 m/s\hat{ }2. The third duration is set based on experience or adjusted based on an implementation environment, which is not limited in embodiments of this application. For example, the third duration is 15 seconds.

For example, the third acceleration is obtained when the head direction of the virtual vehicle is forward, the driving speed of the virtual vehicle is 0, and the touch and hold/long press operation triggered on the foot brake component is received. The third acceleration is 5 m/s\hat{ }2. In this case, the virtual vehicle is controlled to travel backward based on the acceleration of 5 m/s\hat{ }2 within 15 seconds.

The player can freely control the virtual vehicle to accelerate, decelerate, reverse, and the like by using the foregoing accelerator component and foot brake component. Control flexibility is high. In addition, it is also conducive to satisfying various needs of the player, such as competition and roaming in a virtual scene.

In one embodiment, based on the driving speed of the virtual vehicle satisfying the speed requirement and the first operation triggered on the foot brake component being received, the driving speed of the virtual vehicle is controlled to be adjusted to a target driving speed within fifth duration. The fifth duration may be set based on experience or may be adjusted based on an implementation environment, which is not limited in embodiments of this application. For example, the fifth duration is 15 seconds. The target driving speed is set based on experience or adjusted based on an implementation environment, which is not limited in embodiments of this application. For example, the target driving speed is 0.

For example, when the virtual vehicle travels at a speed of 100 kilometers per hour (km/h), a touch and hold/long press operation triggered on the foot brake component is received, to control the driving speed of the virtual vehicle to drop to 0 within 15 seconds.
Operation 202: Display, in response to receiving a first operation triggered on the first direction component, a virtual vehicle of which a head direction is changed.

The first direction component is configured to adjust the driving direction of the virtual vehicle. The first operation triggered on the first direction component may be a touch and hold/long press operation on the first direction component or may be another operation, which is not limited in embodiments of this application.

In one embodiment, when the first operation triggered on the first direction component is received, the virtual vehicle of which the head direction is changed is displayed in the virtual scene. A changing direction of the head direction of the virtual vehicle is the same as the direction corresponding to the first direction component. Displaying the virtual vehicle of which the head direction is changed means that a head direction of a displayed virtual vehicle (that is, the virtual vehicle displayed in operation 201) is changed.
Operation 203: Control, in response to receiving the second operation triggered on the foot brake component and the third operation triggered on the accelerator component sequentially within duration of the first operation, a driving speed of the virtual vehicle at a target time point being greater than a speed threshold, and a driving state of the virtual vehicle at the target time point being a straight-forward driving state, the virtual vehicle to perform inertial drift in the direction corresponding to the first direction component.

The direction corresponding to the first direction component may alternatively be understood as a direction indicated by the first direction component, in other words, a direction specified by the first direction component, a direction determined based on the first direction component, or a direction defined by the first direction component.

To be specific, operation 202 and operation 203 may be considered as: determining, in response to receiving a first operation triggered on a first direction component and receiving a second operation triggered on a foot brake component and a third operation triggered on an accelerator component sequentially within duration of the first operation, a trigger moment of the third operation, and determining a target time point based on the trigger moment of the third operation; determine a driving speed and a driving state of the virtual vehicle at the target time point; and controlling, in response to the driving speed of the virtual vehicle at the target time point being greater than a speed threshold and the driving state of the virtual vehicle at the target time point being a straight-forward driving state, the virtual vehicle to perform inertial drift in a direction indicated by the first direction component, the straight-forward driving state being configured for indicating that the virtual vehicle travels in a non-drift state on a carrier surface in the virtual scene.

Operation 202 and operation 203 are both operations performed after the first operation triggered on the first direction component is received. Within the duration of the first operation, regardless of whether the inertial drift is performed, the head direction of the virtual vehicle can be changed. For example, a changing trend can be generated for the direction indicated by the first direction component. For example, if the first direction component is a left direction key, and the direction indicated by the first direction component is left. Provided that the first operation triggered on the left direction key is received, within the duration of the first operation, the head direction of the virtual vehicle may be continuously changed, so that the virtual vehicle has a tendency to turn left.

In other words, in this embodiment of this application, if the virtual vehicle needs to be controlled to perform the inertial drift in the direction corresponding to the first direction component, three conditions need to be satisfied, namely: the second operation triggered on the foot brake component and the third operation triggered on the accelerator component are sequentially received within the duration of the first operation; the driving speed of the virtual vehicle at the target time point is greater than the speed threshold; and the driving state of the virtual vehicle at the target time point is the straight-forward driving state. If the condition that the driving speed of the virtual vehicle at the target time point is greater than the speed threshold is not satisfied, it means that a current driving speed of the virtual vehicle is too low to implement the inertial drift. In this case, the condition that the driving speed of the virtual vehicle at the target time point is greater than the speed threshold needs to be satisfied. If the condition that the driving state of the virtual vehicle at the target time point is the straight-forward driving state is not satisfied, it means that the virtual vehicle is not in the straight-forward driving state currently. Because the straight-forward driving state is configured for indicating that a virtual vehicle travels in the non-drift state on the carrier surface in the virtual scene, not being in the straight-forward driving state represents that the virtual vehicle has left the carrier surface (in other words, the virtual vehicle is airborne), or the virtual vehicle is on the carrier surface (in other words, the virtual vehicle does not leave the carrier surface) but is already in a drift state. Regardless of which condition, the inertial drift cannot be implemented. In this case, the condition that the driving state of the virtual vehicle at the target time point is the straight-forward driving state needs to be satisfied.

The target time point is determined based on the trigger moment of the third operation. A difference between the target time point and the trigger moment of the third operation satisfies a difference requirement. In one embodiment, when the difference between the target time point and the trigger moment of the third operation is less than a difference threshold, it is determined that the difference between the target time point and the trigger moment of the third operation satisfies the difference requirement. For example, the difference threshold is set based on experience or adjusted based on an implementation environment, which is not limited in embodiments of this application. For example, the difference threshold is 5 seconds. The target time point may be before the trigger moment of the third operation or after the trigger moment of the third moment, which is not limited in embodiments of this application.

In one embodiment, the first operation triggered on the first direction component may be a touch and hold/long press operation on the first direction component or may be another operation, the second operation triggered on the foot brake component may be a tap/click operation on the foot brake component, and the third operation triggered on the accelerator component may be a tap/click operation on the accelerator component, which are not limited in embodiments of this application. For example, the second operation triggered on the foot brake component and the third operation triggered on the accelerator component may alternatively be determined to be received sequentially when a selection operation on the foot brake component is detected first and a sliding operation from the foot brake component to the accelerator component is detected later.

In this embodiment of this application, controlling the virtual vehicle to perform the inertial drift in the direction corresponding to the first direction component may mean controlling the virtual vehicle to perform the inertial drift and a process of the inertial drift causing the virtual vehicle to turn in the direction corresponding to the first direction component. For example, if the direction corresponding to the first direction component is left, controlling the virtual vehicle to perform the inertial drift on a left side may mean controlling the virtual vehicle to perform the inertial drift and a process of the inertial drift causing the virtual vehicle to turn to the left, in other words, may mean the vehicle performing the inertial drift during turning to the left and the vehicle performing the inertial drift to form an arc turning to the left.

In a possible implementation, before the virtual vehicle is controlled to perform the inertial drift in the direction corresponding to the first direction component, the driving speed and the driving state of the virtual vehicle at the target time point need to be determined first, and in this case, the target time point needs to be determined first. A manner of determining the target time point is not limited in embodiments of this application. For example, because the target time point is determined based on the trigger moment of the third operation, in this embodiment of this application, during determining the target time point, the trigger moment of the third operation is determined first, and then the target time point is determined based on the trigger moment of the third operation. For example, determining the trigger moment of the third operation and determining the target time point based on the trigger moment of the third operation include: determining the trigger moment of the third operation; and determining the target time point based on the trigger moment of the third operation and the difference threshold, to cause the difference between the target time point and the trigger moment of the third operation to be less than the difference threshold.

In some embodiments, the determining the target time point based on the trigger moment of the third operation and the difference threshold includes: determining a target time period based on the difference threshold and the trigger moment of the third operation; and randomly determining a time point in the target time period as the target time point. In this way, the difference between the target time point and the trigger moment of the third operation can be less than the difference threshold.

For example, the lower limit of the target time period is the trigger moment of the third operation minus the difference threshold, and the upper limit of the target period is the trigger moment of the third operation plus the difference threshold. To be specific, the determining a target time period based on the difference threshold and the trigger moment of the third operation includes: using a moment obtained by subtracting the difference threshold from the trigger moment of the third operation as a start moment, using a moment obtained by adding the trigger moment of the third operation to the difference threshold as an end moment, and using a time period between the start moment and the end moment as the target time period. For example, if the trigger moment of the third operation is 16:57:10, and the difference threshold is 5 seconds, the determined target time period is 16:57:05 to 16:57:15. A time point is randomly determined in the target time period as the target time point. For example, 16:57:11 is the target time point.

In an exemplary embodiment, a manner of obtaining the driving speed and the driving state of the virtual vehicle at the current time point (that is, the target time point) includes: obtaining a first image, the first image being an image of the virtual vehicle at the target time point; and determining the driving speed and the driving state of the virtual vehicle at the target time point based on the first image.

There are at least the following two manners to obtain the first image.

In the first manner, the first image is obtained from storage space of the terminal device.

In one embodiment, a plurality of images and correspondences between the images and time points are stored in the storage space of the terminal device. Each image is an image of the virtual vehicle at a corresponding time point. After the terminal device determines the target time point, an image among the plurality of images stored in the storage space of the terminal device and of which a time point is the same as the target time point is used as the first image.

In the second manner, the terminal device obtains the first image through interaction with the server.

In a possible implementation, the server stores a plurality of images and correspondences between the images and time points. Each image is an image of the virtual vehicle at a corresponding time point. After determining the target time point, the terminal device sends an image obtaining request to the server. The image obtaining request carries the target time point. The image obtaining request is configured for obtaining the first image of the virtual vehicle at the target time point. After receiving the image obtaining request, the server parses the image obtaining request to obtain the target time point. Further, the image among the plurality of images and of which the time point is the same as the target time point is used as the first image. The server sends the first image to the terminal device, in other words, the terminal device obtains the first image.

Any one of the foregoing manners may be selected to obtain the first image, which is not limited in embodiments of this application.

In an exemplary embodiment, the determining the driving speed and the driving state of the virtual vehicle at the target time point based on the first image includes: determining a driving speed corresponding to the first image as the driving speed of the virtual vehicle at the target time point, for example, the driving speed corresponding to the first image being displayed in the first image, and the terminal device determining the driving speed displayed in the first image as the driving speed of the virtual vehicle at the target time point, and for another example, the driving speed corresponding to the first image being not displayed in the first image, and the terminal device obtaining the driving speed corresponding to the first image from the storage space of the terminal device, or the terminal device obtaining the driving speed corresponding to the first image through the interaction with the server; determining, based on a wheel of the virtual vehicle in the first image not leaving the carrier surface and the virtual vehicle not being in a drift state, that the driving state of the virtual vehicle at the target time point is the straight-forward driving state; determining, based on a wheel of the virtual vehicle in the first image not leaving the carrier surface, that the driving state of the virtual vehicle at the target time point is a non-straight-forward driving state; or determining, based on a wheel of the virtual vehicle in the first image not leaving the carrier surface and the virtual vehicle being in a drift state, that the driving state of the virtual vehicle at the target time point is a non-straight-forward driving state. For example, the determining, based on a wheel of the virtual vehicle in the first image not leaving the carrier surface, that the driving state of the virtual vehicle at the target time point is a non-straight-forward driving state may be considered as: determining, based on the wheel of the virtual vehicle in the first image having left the carrier surface, that the driving state of the virtual vehicle at the target time point is the non-straight-forward driving state.

The carrier surface may be a ground, a surface of a bridge, a surface of a house, or a surface of another object, which is not limited in embodiments of this application. The straight-forward driving state is configured for indicating that the virtual vehicle accelerates to travel in a non-drift state. Because the virtual vehicle is in the non-drift state, the virtual vehicle is on the carrier surface, and the straight-forward driving state is configured for indicating that the virtual vehicle accelerates to travel forward in the non-drift state on the carrier surface. The accelerating to travel forward may mean traveling forward in a current driving direction of the virtual vehicle, and is not limited to traveling toward a specified direction. A driving speed of the virtual vehicle in the straight-forward driving state is higher than a driving speed of the virtual vehicle during performing the inertial drift. In one embodiment, the wheel of the virtual vehicle not leaving the carrier surface means that at least one wheel of the virtual vehicle does not leave the carrier surface.

In one embodiment, in response to the virtual vehicle being in the drift state, the first image further includes first information. The first information is configured for indicating that the virtual vehicle is in the drift state. In response to the first image not including the first information, the virtual vehicle is not in the drift state. In response to the first image including the first information, the virtual vehicle is in the drift state.

In a possible implementation, the speed threshold may be set based on experience or may be adjusted based on an implementation environment, which is not limited in embodiments of this application. For example, the speed threshold is 100 km/h.

In one embodiment, a notification message may alternatively be displayed while the virtual vehicle is controlled to perform the inertial drift in the direction corresponding to the first direction component. The notification message is configured for indicating the driving state of the virtual vehicle. For example, the notification message may be displayed in the vehicle control interface.

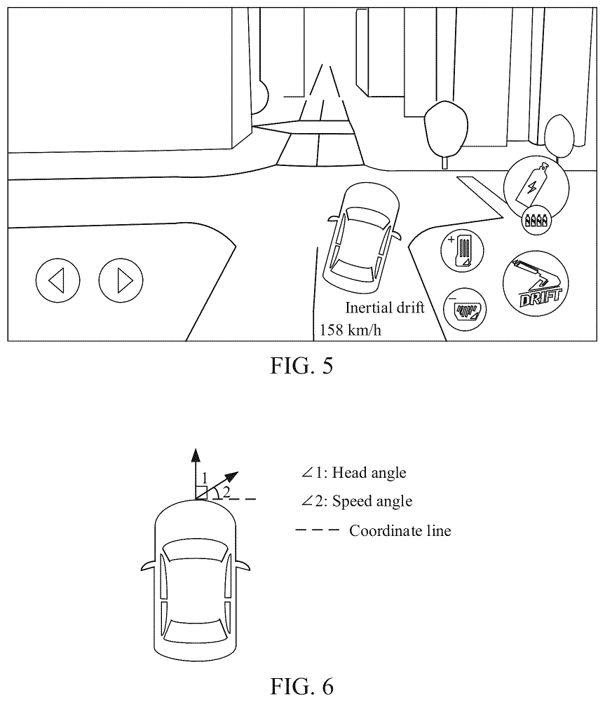

FIG. 5 is a schematic diagram of display of a notification message according to an embodiment of this application. In FIG. 5, a virtual vehicle is performing inertial drift in a direction corresponding to a first direction component. “Inertial drift” shown in FIG. 5 is a notification message, in other words, a current driving state of the virtual vehicle is an inertial drift state. In one embodiment, a driving speed of “158 km/h” of the virtual vehicle is also shown in FIG. 5.

After the virtual vehicle is controlled to perform the inertial drift in the direction corresponding to the first direction component, a drift angle of the virtual vehicle at a current moment may further be determined. The driving state of the virtual vehicle is adjusted based on the drift angle of the virtual vehicle at the current moment.

A process of determining the drift angle of the virtual vehicle at the current moment includes but is not limited to: determining a driving angle and a head angle of the virtual vehicle at the current moment; and determining the drift angle of the virtual vehicle at the current moment based on the driving angle and the head angle of the virtual vehicle at the current moment. In one embodiment, the head angle is an internal angle between a line from a tail of the vehicle pointing to a head and a coordinate line. The coordinate line is set based on experience or adjusted based on an implementation environment. For example, the coordinate line is a horizontal line. An absolute value of a difference of the driving angle and the head angle of the virtual vehicle at the current moment is used as the drift angle of the virtual vehicle at the current moment.

When the virtual vehicle normally travels forward, because a speed direction of the virtual vehicle is substantially a head direction, in other words, a speed angle of the virtual vehicle is substantially the head angle, it is determined that the drift angle of the virtual vehicle is approximately equal to 0 degrees. When the virtual vehicle reverses, because the speed direction of the virtual vehicle is opposite to the head direction, in other words, the speed angle of the virtual vehicle is 270 degrees, and the head angle of the virtual vehicle is 90 degrees, it is determined that the drift angle of the virtual vehicle is 180 degrees.

FIG. 6 is a schematic diagram of display of a speed angle and a head angle of a virtual vehicle at a current moment according to an embodiment of this application. In FIG. 6, 21 is a head angle of a virtual vehicle at a current moment, and 21 is an included angle between an arrow vertically upward and a coordinate line in FIG. 6. 42 is a speed angle of the virtual vehicle at the current moment, and <2 is an included angle between an arrow tilted to the upper right and the coordinate line in FIG. 6. A dashed line is the coordinate line.

For example, the head angle of the virtual vehicle at the current moment is 30 degrees, and a driving angle is 10 degrees. In this case, it is determined that a drift angle of the virtual vehicle at the current moment is 20 degrees.

A manner of determining a driving angle and a head angle of the virtual vehicle at the current moment is not limited in embodiments of this application. In one embodiment, a second image is obtained. The second image is an image of the virtual vehicle at the current moment. The head angle of the virtual vehicle at the current moment is determined based on the second image. A driving angle of the virtual vehicle at a first moment is obtained. The first moment is adjacent to the current moment and earlier than the current moment. The driving angle of the virtual vehicle at the current moment is determined based on the head angle of the virtual vehicle at the current moment and the driving angle of the virtual vehicle at the first moment.

In one embodiment, the driving angle of the virtual vehicle at the current moment is determined based on the head angle of the virtual vehicle at the current moment and the driving angle of the virtual vehicle at the first moment with reference to traction of the virtual vehicle. For example, an angle difference between the head angle of the virtual vehicle at the current moment and the driving angle of the virtual vehicle at the first moment is determined. A product of the angle difference and the traction of the virtual vehicle is determined. A sum of the product and the driving angle of the virtual vehicle at the first moment is determined as the driving angle of the virtual vehicle at the current moment. In other words, the driving angle of the virtual vehicle at the current moment is determined based on the following Formula (1).

$$V\_i = S * ( d\_i - V\_t ) + V\_t \qquad Formula ( 1 )$$

In the foregoing Formula (1), V_i is the driving angle of the virtual vehicle at the current moment, S is the traction, d_i is the head angle of the virtual vehicle at the current moment, and V_t is the driving angle of the virtual vehicle at the first moment. The traction is set based on experience or adjusted based on an implementation environment, which is not limited in embodiments of this application. For example, the traction is 0.5.

For example, the head angle of the virtual vehicle at the current moment is 105 degrees, the driving angle of the virtual vehicle at the first moment is 15 degrees, and the traction is 0.5. It is determined, based on the foregoing Formula (1), that the driving angle of the virtual vehicle at the current moment is 0.5*(105−15)+15=60 degrees. It is further determined that the drift angle of the virtual vehicle at the current moment is 45 degrees.

In one embodiment, a process of adjusting the driving state of the virtual vehicle based on the drift angle of the virtual vehicle at the current moment includes the following three situations.

Situation one: Based on the drift angle of the virtual vehicle at the current moment being smaller than a first angle, the virtual vehicle is controlled to travel in the straight-forward driving state in the direction corresponding to the first direction component.

In one embodiment, a driving speed of the virtual vehicle in the straight-forward driving state is higher than a driving speed of the virtual vehicle during performing the inertial drift. The first angle may be set based on experience, or may be adjusted based on an implementation environment, which is not limited in embodiments of this application. For example, the first angle is 13 degrees.

For example, the drift angle of the virtual vehicle at the current moment is 12 degrees, and the first angle is 13 degrees. Because the drift angle of the virtual vehicle at the current moment is smaller than the first angle, the virtual vehicle is controlled to travel in the straight-forward driving state in the direction corresponding to the first direction component.

Situation two: Based on the drift angle of the virtual vehicle at the current moment being larger than a second angle, the virtual vehicle is controlled to perform general drift different from the inertial drift in the direction corresponding to the first direction component.

In one embodiment, a driving speed of the virtual vehicle during performing the general drift is lower than the driving speed of the virtual vehicle during performing the inertial drift. The second angle is larger than the first angle. The first angle is configured for controlling the virtual vehicle to travel in the straight-forward driving state in the direction indicated by the first direction component. In other words, when the virtual vehicle performs the general drift, the driving speed decreases fast and a deceleration acceleration is great. However, when the virtual vehicle performs the inertial drift, the driving speed decreases slowly and the deceleration acceleration is less. The second angle is set based on experience or adjusted based on an implementation environment, which is not limited in embodiments of this application. For example, the second angle is 30 degrees.

For example, the drift angle of the virtual vehicle at the current moment is 33 degrees, and the second angle is 30 degrees. Because the drift angle of the virtual vehicle at the current moment is larger than the second angle, the virtual vehicle is controlled to perform the general drift in the direction corresponding to the first direction component.

Situation three: Based on the drift angle of the virtual vehicle at the current moment being not smaller than a first angle and not larger than a second angle, the virtual vehicle is controlled to perform the inertial drift in the direction corresponding to the first direction component. The second angle is larger than the first angle.

For example, the drift angle of the virtual vehicle at the current moment is 20 degrees, the first angle is 13 degrees, and the second angle is 30 degrees. Because the drift angle of the virtual vehicle at the current moment is not smaller than the first angle and not larger than the second angle, the virtual vehicle is controlled to perform the inertial drift in the direction corresponding to the first direction component.

In one embodiment, the hand brake component may alternatively be displayed in the vehicle control interface. The hand brake component is configured to adjust the driving speed of the virtual vehicle. After the virtual vehicle is controlled to perform the inertial drift in the direction corresponding to the first direction component, the virtual vehicle is controlled, in response to receiving a fourth operation triggered on the hand brake component, to perform the general drift different from the inertial drift in the direction corresponding to the first direction component. The driving speed of the virtual vehicle during performing the general drift is lower than the driving speed of the virtual vehicle during performing the inertial drift. The fourth operation triggered on the hand brake component may be a tap/click operation on the hand brake component or may be another operation, which is not limited in embodiments of this application.

In one embodiment, a notification message may alternatively be displayed when the virtual vehicle is controlled to perform the general drift in the direction corresponding to the first direction component. The notification message is configured for indicating the driving state of the virtual vehicle. A display process of the notification message is similar to a display process when the virtual vehicle is controlled to perform the inertial drift in the direction corresponding to the first direction component. Details are not described herein again.

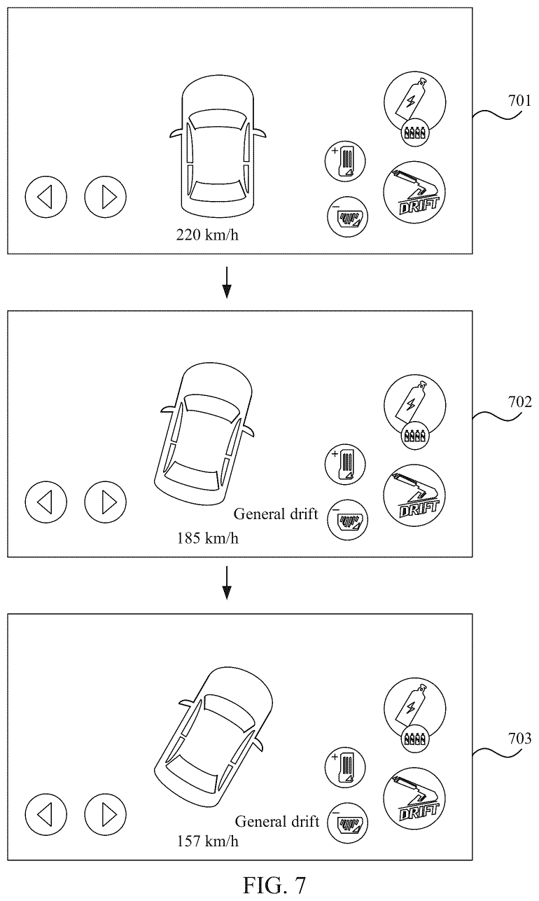

FIG. 7 is a schematic diagram of display of a virtual vehicle during performing general drift according to an embodiment of this application. In 701 of FIG. 7, the virtual vehicle is in a straight-forward driving state, and a driving speed of the virtual vehicle is 220 km/h. In 702 of FIG. 7, the virtual vehicle is in a general drift state, and the driving speed of the virtual vehicle is 185 km/h. In 703 of FIG. 7, the virtual vehicle is in the general drift state, and the driving speed of the virtual vehicle is 157 km/h. After the general drift starts, the driving speed of the virtual vehicle quickly drops to 157 km/h within two seconds and remains.

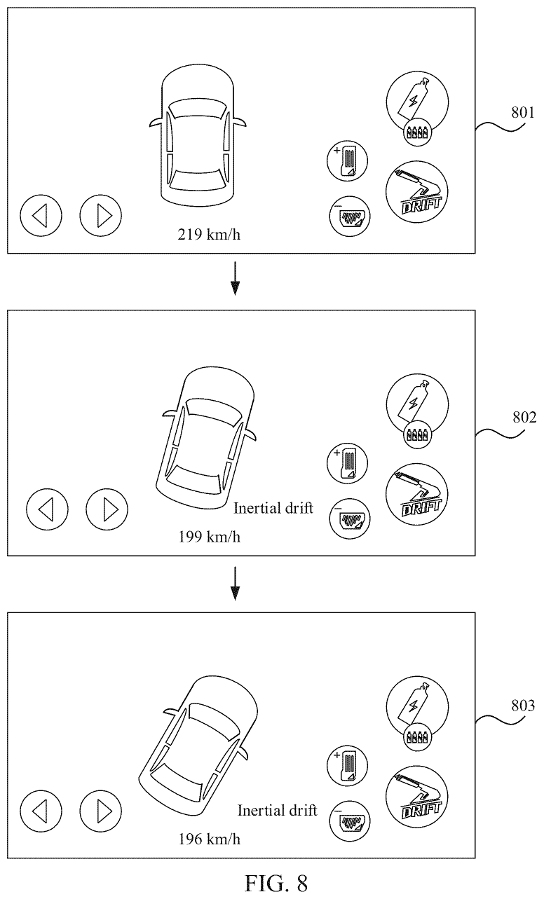

FIG. 8 is a schematic diagram of display of a virtual vehicle during performing inertial drift according to an embodiment of this application. In 801 of FIG. 8, the virtual vehicle is in a straight-forward driving state, and a driving speed of the virtual vehicle is 219 km/h. In 802 of FIG. 8, the virtual vehicle is in an inertial drift state, and the driving speed of the virtual vehicle is 199 km/h. In 803 of FIG. 8, the virtual vehicle is in the inertial drift state, and the driving speed of the virtual vehicle is 196 km/h. After the inertial drift starts, the driving speed of the virtual vehicle quickly drops to 196 km/h within one second and remains.

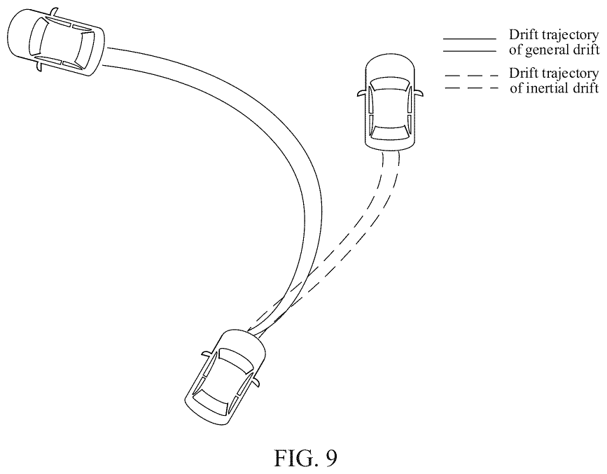

FIG. 9 is a schematic diagram of display of a drift trajectory of general drift and a drift trajectory of inertial drift according to an embodiment of this application. A drift trajectory shown by dashed lines is the drift trajectory of the inertial drift, and a drift trajectory shown by solid lines is the drift trajectory of the general drift. It can be learned from FIG. 9 that the inertial drift is suitable for a large and gentle curve. In other words, the virtual vehicle only turns at a weak degree during the inertial drift, and the inertial drift is suitable for a curve having a small arc.

In the foregoing method, when a virtual vehicle is controlled to perform inertial drift, a player only needs to operate a direction component, a foot brake component, and an accelerator component to control the virtual vehicle to perform the inertial drift. In this way, the method improves control of the player on a vehicle, to enable a vehicle control manner to be flexible, thereby improving game experience of the player.

In addition, the direction component, the accelerator component, and the foot brake component are operated to control the virtual vehicle to perform the inertial drift, and this is consistent with a manner of operating a real vehicle to perform inertial drift, so that authenticity of controlling the virtual vehicle for performing the inertial drift is high.

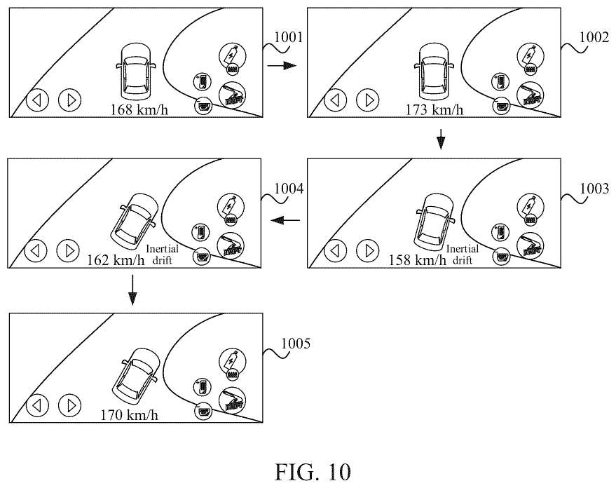

FIG. 10 is a schematic diagram of a process of controlling a virtual vehicle to perform inertial drift according to an embodiment of this application. In 1001 of FIG. 10, the virtual vehicle prepares to travel around a gentle curve having a long inner arc. Using general drift may result in a vehicle route not fitting the curve and a speed of traveling around the curve being slow. A driving speed of the virtual vehicle in 1001 of FIG. 10 is 168 km/h. In 1002 of FIG. 10, an interaction object taps/clicks a right direction component to adjust a head direction of the virtual vehicle. In 1003 of FIG. 10, the interaction object touches and holds/long presses the right direction component, taps/clicks a foot brake component, taps/clicks an accelerator component, and a driving speed and a driving state of the virtual vehicle when the accelerator component is tapped/clicked are determined. Based on the driving speed of the virtual vehicle being greater than a speed threshold when the accelerator component is tapped/clicked and the driving state being a straight-forward driving state, the virtual vehicle is controlled to perform the inertial drift to the right, to cause the vehicle to slide sideways and fit the curve to travel around the curve at a small angle, and a notification message is displayed to prompt the interaction object that the virtual vehicle is in an inertial drift state. In 1004 of FIG. 10, the interaction object adjusts a direction component in many times to control a drift angle of the virtual vehicle to be between a first angle and a second angle, to maintain the inertial drift state of the virtual vehicle. In 1005 of FIG. 10, when the interaction object wants to stop the inertial drift, a left direction component may be triggered to cause the drift angle to be smaller than the first angle. In this case, the virtual vehicle exits the inertial drift and travels in the straight-forward driving state.

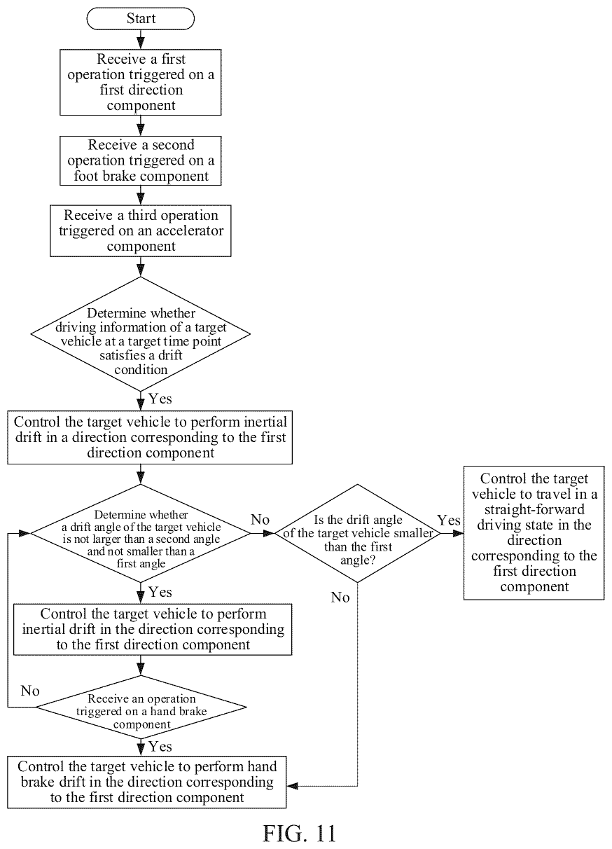

FIG. 11 is a flowchart of a virtual vehicle control method according to an embodiment of this application. In FIG. 11, in response to receiving a first operation triggered on a first direction component, receiving a second operation triggered on a foot brake component, and receiving a third operation triggered on an accelerator component, it is determined whether driving information of a virtual vehicle (that is, a target vehicle shown in FIG. 11) at a target time point satisfies a drift condition. Based on the driving information of the virtual vehicle at the target time point satisfying the drift condition, the virtual vehicle is controlled to perform inertial drift in a direction corresponding to the first direction component. The driving information of the virtual vehicle at the target time point satisfying the drift condition means that a driving speed of the virtual vehicle at the target time point being greater than a speed threshold and a driving state of the virtual vehicle at the target time point being a straight-forward driving state.

Whether a drift angle of the virtual vehicle is not larger than a second angle and not smaller than a first angle is determined. Based on the drift angle of the virtual vehicle being not larger than the second angle and not smaller than the first angle, the virtual vehicle is controlled to perform the inertial drift in the direction corresponding to the first direction component. In response to receiving an operation triggered on a hand brake component, the virtual vehicle is controlled to perform general drift (that is, hand brake drift shown in FIG. 11) in the direction corresponding to the first direction component.

Based on the drift angle of the virtual vehicle not being between the first angle and the second angle, whether the drift angle of the virtual vehicle is smaller than the first angle is determined. Based on the drift angle of the virtual vehicle being smaller than the first angle, the virtual vehicle is controlled to travel in the straight-forward driving state in the direction corresponding to the first direction component. Based on the drift angle of the virtual vehicle not being smaller than the first angle (in other words, the drift angle of the virtual vehicle being larger than the second angle), the virtual vehicle is controlled to perform the general drift in the direction corresponding to the first direction component.

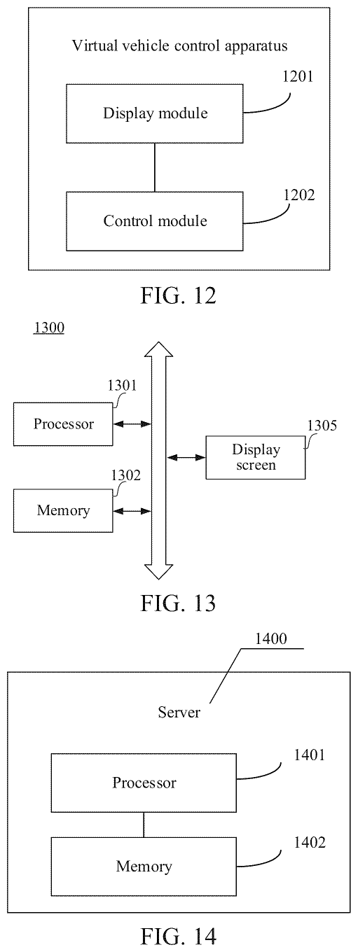

FIG. 12 is a schematic diagram of a structure of a vehicle control apparatus (that is, a virtual vehicle control apparatus) according to an embodiment of this application. As shown in FIG. 12, the apparatus includes:
a display module 1201, configured to display a virtual vehicle in a virtual scene,
the display module 1201 being further configured to display, in response to receiving a first operation triggered on a first direction component, the virtual vehicle of which a head direction is changed, in other words, causing the head direction of the displayed virtual vehicle to be changed; and
a control module 1202, configured to control, in response to receiving a second operation triggered on a foot brake component and a third operation triggered on an accelerator component sequentially within duration of the first operation, a driving speed of the virtual vehicle at a target time point being greater than a speed threshold, and a driving state of the virtual vehicle at the target time point being a straight-forward driving state, the virtual vehicle to perform inertial drift in a direction corresponding to the first direction component. The target time point is determined based on a trigger moment of the third operation.

For example, the apparatus provided in this embodiment of this application further includes a determining module. A part or all of the operations performed by the display module 1201 may be completed by the determining module. For example, the determining module is configured to: determine, in response to receiving a first operation triggered on a first direction component, and receiving a second operation triggered on a foot brake component and a third operation triggered on an accelerator component sequentially within duration of the first operation, a trigger moment of the third operation; determine a target time point based on the trigger moment of the third operation; and determine a driving speed and a driving state of the virtual vehicle at the target time point. Correspondingly, the control module 1202 is configured to control, in response to the driving speed of the virtual vehicle at the target time point being greater than a speed threshold and the driving state of the virtual vehicle at the target time point being a straight-forward driving state, the virtual vehicle to perform inertial drift in a direction indicated by the first direction component, the straight-forward driving state being configured for indicating that the virtual vehicle travels in a non-drift state on a carrier surface in the virtual scene.

In a possible implementation, the apparatus further includes:
a determining module, configured to: obtain a first image in response to receiving the third operation triggered on the accelerator component, the first image being an image of the virtual vehicle at the target time point; and determine the driving speed and the driving state of the virtual vehicle at the target time point based on the first image.

In a possible implementation, the determining module is configured to: determine a driving speed corresponding to the first image as the driving speed of the virtual vehicle at the target time point, for example, determine a driving speed displayed in the first image as the driving speed of the virtual vehicle at the target time point; determine, based on a wheel of the virtual vehicle in the first image not leaving the carrier surface and the virtual vehicle not being in a drift state, that the driving state of the virtual vehicle at the target time point is the straight-forward driving state; determine, based on a wheel of the virtual vehicle in the first image not leaving the carrier surface (having left the carrier surface), that the driving state of the virtual vehicle at the target time point is a non-straight-forward driving state; or determine, based on a wheel of the virtual vehicle in the first image not leaving the carrier surface and the virtual vehicle being in a drift state, that the driving state of the virtual vehicle at the target time point is a non-straight-forward driving state.

In a possible implementation, the control module 1202 is further configured to control, based on a drift angle of the virtual vehicle at a current moment being smaller than a first angle, the virtual vehicle to travel in the straight-forward driving state in the direction corresponding to the first direction component, a driving speed of the virtual vehicle in the straight-forward driving state being higher than a driving speed of the virtual vehicle during performing the inertial drift.

In a possible implementation, the determining module is further configured to: determine a driving angle and a head angle of the virtual vehicle at the current moment; and determine the drift angle of the virtual vehicle at the current moment based on the driving angle and the head angle of the virtual vehicle at the current moment.

In a possible implementation, the control module 1202 is further configured to control, based on a drift angle of the virtual vehicle at a current moment being larger than a second angle, the virtual vehicle to perform general drift different from the inertial drift in the direction corresponding to the first direction component, a driving speed of the virtual vehicle during performing the general drift being lower than a driving speed of the virtual vehicle during performing the inertial drift, and the second angle being larger than the first angle, and the first angle being configured for controlling the virtual vehicle to travel in the straight-forward driving state in the direction indicated by the first direction component.

In a possible implementation, the control module 1202 is further configured to control, based on a drift angle of the virtual vehicle at a current moment being not smaller than a first angle and not larger than a second angle, the virtual vehicle to perform the inertial drift in the direction corresponding to the first direction component, the second angle being larger than the first angle.

In a possible implementation, the determining module is configured to: obtain a second image, the second image being an image of the virtual vehicle at the current moment; determine the head angle of the virtual vehicle at the current moment based on the second image; obtain a driving angle of the virtual vehicle at a first moment, the first moment being adjacent to the current moment and earlier than the current moment; and determine the driving angle of the virtual vehicle at the current moment based on the head angle of the virtual vehicle at the current moment and the driving angle of the virtual vehicle at the first moment.

In a possible implementation, the determining module is configured to: determine an angle difference between the head angle of the virtual vehicle at the current moment and the driving angle of the virtual vehicle at the first moment, and determine a product of the angle difference and traction of the virtual vehicle; and determine a sum of the product and the driving angle of the virtual vehicle at the first moment as the driving angle of the virtual vehicle at the current moment.

In a possible implementation, the control module 1202 is further configured to control, in response to receiving a fourth operation triggered on a hand brake component, the virtual vehicle to perform the general drift different from the inertial drift in the direction corresponding to the first direction component, the driving speed of the virtual vehicle during performing the general drift being lower than the driving speed of the virtual vehicle during performing the inertial drift, and the hand brake component being configured to adjust the driving speed of the virtual vehicle.

In a possible implementation, the display module 1201 is further configured to display a notification message, the notification message being configured for indicating (or informing) a current driving state of the virtual vehicle.

In a possible implementation, the apparatus further includes:
an obtaining module, configured to obtain a first acceleration based on a head direction of the virtual vehicle being a first direction and the third operation triggered on the accelerator component being received, the first acceleration being configured for increasing the driving speed of the virtual vehicle; and
the control module 1202, further configured to control the virtual vehicle to travel in the first direction based on the first acceleration within first duration.

In a possible implementation, the obtaining module is further configured to obtain a second acceleration based on the head direction of the virtual vehicle being the first direction, the driving speed of the virtual vehicle satisfying a speed requirement, and the second operation triggered on the foot brake component being received, the second acceleration being configured for reducing the driving speed of the virtual vehicle.

The control module 1202 is further configured to control the virtual vehicle to travel in the first direction based on the second acceleration within second duration.

In a possible implementation, the obtaining module is further configured to obtain a third acceleration based on the head direction of the virtual vehicle being the first direction, the driving speed of the virtual vehicle not satisfying the speed requirement, and a first operation triggered on the foot brake component being received, the third acceleration being configured for increasing the driving speed of the virtual vehicle.

The control module 1202 is further configured to control the virtual vehicle to travel in a second direction based on the third acceleration within third duration, the second direction being opposite to the first direction.

In a possible implementation, the obtaining module is further configured to obtain a fourth acceleration in response to receiving a fifth operation triggered on an acceleration component, the fourth acceleration being configured for increasing the driving speed of the virtual vehicle, the fourth acceleration being higher than the first acceleration, and the acceleration component being configured to adjust the driving speed of the virtual vehicle.

The control module 1202 is further configured to control the virtual vehicle to travel in the head direction of the virtual vehicle based on the fourth acceleration within fourth duration.

When the foregoing apparatus controls a virtual vehicle to perform inertial drift, a player only needs to operate a direction component, a foot brake component, and an accelerator component to control the virtual vehicle to perform the inertial drift. In this way, control of the player on a vehicle is improved, to enable a vehicle control manner to be flexible, thereby improving game experience of the player.

In addition, the direction component, the accelerator component, and the foot brake component are operated to control the virtual vehicle to perform the inertial drift, and this is consistent with a manner of operating a real vehicle to perform inertial drift, so that authenticity of controlling the virtual vehicle for performing the inertial drift is high.

When the apparatus implements functions of the apparatus, only division of the foregoing function modules is used as an example for description. In the practical application, the functions may be allocated to and completed by different function modules according to requirements. In other words, an internal structure of the device is divided into different function modules, to complete all or some of the functions described above. In addition, the apparatus provided in the foregoing embodiments and the method embodiments belong to the same concept. For details of the specific implementation process, refer to the method embodiments. Details are not described herein again.

FIG. 13 is a block diagram of a structure of a terminal device 1300 according to an exemplary embodiment of this application. The terminal device 1300 may be a portable mobile terminal, such as a smartphone, a tablet computer, a Moving Picture Experts Group Audio Layer III (MP3) player, a Moving Picture Experts Group Audio Layer IV (MP4) player, a notebook computer, or a desktop computer. The terminal device 1300 may also be referred to as another name such as user equipment, a portable terminal, a laptop terminal, or a desktop terminal.

Generally, the terminal device 1300 includes a processor 1301 and a memory 1302.

The processor 1301 may include one or more processing cores, for example, a 4-core processor or an 8-core processor. The processor 1301 may be implemented in at least one hardware form of digital signal processing (DSP), a field-programmable gate array (FPGA), and a programmable logic array (PLA). The processor 1301 may alternatively include a main processor and a coprocessor. The main processor is a processor configured to process data in an awake state, and is also referred to as a central processing unit (CPU). The coprocessor is a low-power-consumption processor configured to process data in a standby state. In some embodiments, the processor 1301 may be integrated with a graphics processing unit (GPU). The GPU is configured to render and draw content that needs to be displayed on a display screen. In some embodiments, the processor 1301 may further include an artificial intelligence (AI) processor. The AI processor is configured to process computing operations related to machine learning.

The memory 1302 may include one or more computer-readable storage media. The computer-readable storage medium may be non-transient. The non-transient computer-readable storage medium is also referred to as a non-transitory computer-readable storage medium. The memory 1302 may further include a high-speed random access memory and a nonvolatile memory, for example, one or more disk storage devices or flash storage devices. In some embodiments, the non-transitory computer-readable storage medium in the memory 1302 is configured to store at least one instruction, and the at least one instruction is configured to be executed by the processor 1301 to implement the virtual vehicle control method provided in the method embodiments of this application.

In some embodiments, the terminal device 1300 may alternatively include a display screen 1305. For example, a virtual vehicle, a notification message, and the like are displayed through the display screen 1305.

The display screen 1305 is configured to display a user interface (UI). The UI may include a graph, text, an icon, a video, and any combination thereof. When the display screen 1305 is a touch display screen, the display screen 1305 also has a capability to collect a touch signal on or above a surface of the display screen 1305. The touch signal may be inputted to the processor 1301 as a control signal for processing. In this case, the display screen 1305 may be further configured to provide a virtual button and/or a virtual keyboard, which is also referred to as a soft button and/or a soft keyboard. In some embodiments, there may be one display screen 1305 disposed on a front panel of the terminal device 1300. In some other embodiments, there may be at least two display screens 1305 disposed on different surfaces of the terminal device 1300 respectively or in a folded design. In some other embodiments, the display screen 1305 may be a flexible display screen disposed on a curved surface or a folded surface of the terminal device 1300. Even, the display screen 1305 may be further configured in a non-rectangular irregular pattern, namely, a special-shaped screen. The display screen 1305 may be prepared by using materials such as a liquid crystal display (LCD) or an organic light-emitting diode (OLED).

A person skilled in the art may understand that the structure shown in FIG. 13 constitutes no limitation on the terminal device 1300, and the terminal device 1300 may include more or fewer components than those shown in the figure, or some components may be combined, or a different component deployment may be used.

FIG. 14 is a schematic diagram of a structure of a server according to an embodiment of this application. The server 1400 may vary a lot due to different configurations or performance, and may include one or more processors (Central Processing Units, CPUs) 1401 and one or more memories 1402. The one or more memories 1402 have at least one piece of program code stored therein. The at least one piece of program code is loaded and executed by the one or more processors 1401 to implement the virtual vehicle control method provided in the foregoing method embodiments. Certainly, the server 1400 may further include components such as a wired or wireless network interface, a keyboard, and an input/output interface, to facilitate input and output. The server 1400 may further include another component configured to implement a function of a device. Details are not described herein.

In an exemplary embodiment, a non-transitory computer-readable storage medium is further provided, having at least one piece of program code stored thereon, the at least one piece of program code being loaded and executed by a processor to cause a computer to implement any one of the foregoing virtual vehicle control methods.

In one embodiment, the foregoing non-transitory computer-readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program or a computer program product is further provided, having at least one computer instruction stored thereon, the at least one computer instruction being loaded and executed by a processor to cause a computer to implement any one of the foregoing virtual vehicle control methods.

Information (including but not limited to user equipment information, user personal information, and the like), data (including but not limited to data for analysis, stored data, displayed data, and the like), and signals in this application are all authorized by users or fully authorized by all parties, and collection, use, and processing of related data need to comply with relevant laws, regulations, and standards of relevant countries and regions. For example, the images in this application are obtained under full authorization.

“Plurality of” mentioned in the specification means two or more. “And/or” describes an association relationship between associated objects and indicates that three relationships may exist. For example, A and/or B may indicate the following three cases: Only A exists, both A and B exist, and only B exists. The character “/” generally indicates an “or” relationship between the associated objects.

The sequence numbers of the foregoing embodiments of this application are merely for description purpose but do not imply the preference among the embodiments.

The foregoing descriptions are merely exemplary embodiments of this application, but are not intended to limit this application. Any modification, equivalent replacement, or improvement made within the principle of this application shall fall within the protection scope of this application.

What is claimed is:

1. A virtual vehicle control method performed by an electronic device, the method comprising:
displaying a virtual vehicle in a virtual scene;
during a continued first operation on a first direction component, receiving a second operation triggered on a foot brake component and a third operation triggered on an accelerator component sequentially;
determining a driving speed and a driving state of the virtual vehicle at a trigger moment of the third operation; and
in response to the driving speed of the virtual vehicle at the trigger moment of the third operation being greater than a speed threshold and the driving state of the virtual vehicle at the target time point being a straight-forward driving state, controlling the virtual vehicle to perform inertial drift in a direction indicated by the first direction component.

2. The method according to claim 1, wherein the determining a driving speed and a driving state of the virtual vehicle at the target time point comprises:
obtaining a first image of the virtual vehicle at the trigger moment of the third operation; and
determining the driving speed and the driving state of the virtual vehicle at the trigger moment of the third operation based on the first image.

3. The method according to claim 2, wherein the determining the driving speed and the driving state of the virtual vehicle at the trigger moment of the third operation based on the first image comprises:
based on whether a wheel of the virtual vehicle in the first image is off the carrier surface and whether the virtual vehicle is in a drift state, determining that the driving state of the virtual vehicle at the trigger moment of the third operation is the straight-forward driving state or a non-straight-forward driving state.

4. The method according to claim 1, wherein the method further comprises:
controlling, based on a drift angle of the virtual vehicle at a current moment being smaller than a first angle, the virtual vehicle to travel in the straight-forward driving state in the direction indicated by the first direction component.

5. The method according to claim 1, wherein the method further comprises:
controlling, based on a drift angle of the virtual vehicle at a current moment being larger than a second angle, the virtual vehicle to perform general drift different from the inertial drift in the direction indicated by the first direction component.

6. The method according to claim 1, wherein the method further comprises:
controlling, based on a drift angle of the virtual vehicle at a current moment being not smaller than a first angle and not larger than a second angle, the virtual vehicle to perform the inertial drift in the direction indicated by the first direction component.

7. The method according to claim 1, wherein the method further comprises:
controlling, in response to receiving a fourth operation triggered on a hand brake component, the virtual vehicle to perform the general drift different from the inertial drift in the direction indicated by the first direction component.

8. An electronic device, comprising a processor and a memory, the memory having at least one piece of program code stored therein, and the at least one piece of program code being loaded and executed by the processor to cause the electronic device to implement a virtual vehicle control method including:
displaying a virtual vehicle in a virtual scene;
during a continued first operation on a first direction component, receiving a second operation triggered on a foot brake component and a third operation triggered on an accelerator component sequentially;
determining a driving speed and a driving state of the virtual vehicle at a trigger moment of the third operation; and
in response to the driving speed of the virtual vehicle at the trigger moment of the third operation being greater than a speed threshold and the driving state of the virtual vehicle at the target time point being a straight-forward driving state, controlling the virtual vehicle to perform inertial drift in a direction indicated by the first direction component.

9. The electronic device according to claim 8, wherein the determining a driving speed and a driving state of the virtual vehicle at the target time point comprises:
obtaining a first image of the virtual vehicle at the trigger moment of the third operation; and
determining the driving speed and the driving state of the virtual vehicle at the trigger moment of the third operation based on the first image.

10. The electronic device according to claim 9, wherein the determining the driving speed and the driving state of the virtual vehicle at the trigger moment of the third operation based on the first image comprises:
based on whether a wheel of the virtual vehicle in the first image is off the carrier surface and whether the virtual vehicle is in a drift state, determining that the driving state of the virtual vehicle at the trigger moment of the third operation is the straight-forward driving state or a non-straight-forward driving state.

11. The electronic device according to claim 8, wherein the method further comprises:
controlling, based on a drift angle of the virtual vehicle at a current moment being smaller than a first angle, the virtual vehicle to travel in the straight-forward driving state in the direction indicated by the first direction component.

12. The electronic device according to claim 8, wherein the method further comprises:
controlling, based on a drift angle of the virtual vehicle at a current moment being larger than a second angle, the virtual vehicle to perform general drift different from the inertial drift in the direction indicated by the first direction component.

13. The electronic device according to claim 8, wherein the method further comprises:
controlling, based on a drift angle of the virtual vehicle at a current moment being not smaller than a first angle and not larger than a second angle, the virtual vehicle to perform the inertial drift in the direction indicated by the first direction component.

14. The electronic device according to claim 8, wherein the method further comprises:
controlling, in response to receiving a fourth operation triggered on a hand brake component, the virtual vehicle to perform the general drift different from the inertial drift in the direction indicated by the first direction component.

15. A non-transitory computer-readable storage medium, having at least one piece of program code stored thereon, the at least one piece of program code being loaded and executed by a processor of an electronic device to cause the electronic device to implement a virtual vehicle control method including:
displaying a virtual vehicle in a virtual scene;
during a continued first operation on a first direction component, receiving a second operation triggered on a foot brake component and a third operation triggered on an accelerator component sequentially;
determining a driving speed and a driving state of the virtual vehicle at a trigger moment of the third operation; and
in response to the driving speed of the virtual vehicle at the trigger moment of the third operation being greater than a speed threshold and the driving state of the virtual vehicle at the target time point being a straight-forward driving state, controlling the virtual vehicle to perform inertial drift in a direction indicated by the first direction component.

16. The non-transitory computer-readable storage medium according to claim 15, wherein the determining a driving speed and a driving state of the virtual vehicle at the target time point comprises:
obtaining a first image of the virtual vehicle at the trigger moment of the third operation; and
determining the driving speed and the driving state of the virtual vehicle at the trigger moment of the third operation based on the first image.

17. The non-transitory computer-readable storage medium according to claim 16, wherein the determining the driving speed and the driving state of the virtual vehicle at the trigger moment of the third operation based on the first image comprises:
based on whether a wheel of the virtual vehicle in the first image is off the carrier surface and whether the virtual vehicle is in a drift state, determining that the driving state of the virtual vehicle at the trigger moment of the third operation is the straight-forward driving state or a non-straight-forward driving state.

18. The non-transitory computer-readable storage medium according to claim 15, wherein the method further comprises:
controlling, based on a drift angle of the virtual vehicle at a current moment being smaller than a first angle, the virtual vehicle to travel in the straight-forward driving state in the direction indicated by the first direction component.

19. The non-transitory computer-readable storage medium according to claim 15, wherein the method further comprises:
controlling, based on a drift angle of the virtual vehicle at a current moment being larger than a second angle, the virtual vehicle to perform general drift different from the inertial drift in the direction indicated by the first direction component.

20. The non-transitory computer-readable storage medium according to claim 15, wherein the method further comprises:
controlling, based on a drift angle of the virtual vehicle at a current moment being not smaller than a first angle and not larger than a second angle, the virtual vehicle to perform the inertial drift in the direction indicated by the first direction component.
